(19) United States
(12) Patent Application Publication
(10) Pub. No.: US 2005/0142447 A1
(43) Pub. Date: Jun. 30, 2005

(54) Negative electrode for lithium secondary battery, method for manufacturing the same and lithium secondary battery

(75) Inventors: Miyuki Nakai, Izumi-shi (JP); Emiko Igaki, Amagasaki-shi (JP); Masashi Shoji, Osaka-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 11/021,982

(22) Filed: Dec. 23, 2004

(30) Foreign Application Priority Data
Dec. 26, 2003 (JP) 2003-434838

(51) Int. Cl. H01M 4/40; H01M 4/62; B05D 5/12

(52) U.S. Cl. 429/231.95; 429/217; 427/123

(57) ABSTRACT

A negative electrode for a lithium secondary battery capable of storing and releasing lithium reversibly includes a collector, and a negative electrode material layer arranged on the collector. The negative electrode material layer contains a thin-film negative electrode material capable of storing and releasing lithium reversibly, and lithium non-storing portions containing a lithium non-storing material are arranged on at least one selected from the group consisting of a surface and an inside of the negative electrode material layer. In this way, a negative electrode for a lithium secondary battery capable of suppressing the deformation accompanying charging and discharging is provided.

### BACKGROUND OF THE INVENTION

1. Field of the Invention

The present invention relates to a negative electrode for a lithium secondary battery, a method for manufacturing the same and a lithium secondary battery using the same.

2. Description of Related Art

In recent years, lithium secondary batteries have been studied and developed actively owing to their high output voltage and high energy density. In particular, there is a demand for lithium secondary batteries that have a low internal resistance and whose capacity does not drop very much due to charging and discharging (that have excellent charge-discharge cycle characteristics).

For the purpose of achieving such lithium secondary batteries, a technology of using thin-film amorphous silicon or microcrystalline silicon for a negative electrode material (a negative active material) is known (for example, see JP 2002-83594 A). JP 2002-83594 A suggests a negative electrode for lithium secondary batteries (hereinafter, also simply referred to as a “negative electrode”) in which a negative electrode material layer of a silicon thin film is formed on a collector. The silicon thin film is formed by a thin-film forming technique such as a chemical vapor deposition (hereinafter, also referred to as CVD) and sputtering.

In general, a negative electrode in which a thin-film negative electrode material is layered on a collector achieves a lower internal resistance than a negative electrode in which particulate negative electrode material is layered on the collector together with a binding agent. In other words, using such a negative electrode, it is possible to provide a lithium secondary battery (hereinafter, also simply referred to as a “battery”) having high electrical generating characteristics.

The material such as silicon is considered to swell and shrink repeatedly while lithium is stored and released. Since the negative electrode in which the silicon thin film is formed on the collector has a high adhesion between the collector and the negative electrode material layer, the collector often expands/shrinks with the swelling and shrinkage of the negative electrode material. Accordingly, with charging and discharging, irreversible deformation such as wrinkling is likely to occur in the negative electrode material layer and the collector. Especially when a highly ductile metal foil such as a copper foil is used as the collector, the degree of deformation tends to be large. The deformation of the negative electrode increases the volume of the electrode or causes the electrochemical reaction to become nonuniform, so that the energy density of the battery may decrease. Also, while swelling/shrinking repeatedly with charging and discharging, there is a possibility that the negative electrode material is reduced to particles and sheds from the collector or, in some cases, the thin-film negative electrode peels off as it is from the collector. This may cause a degradation of the charge-discharge cycle characteristics of the battery.

In order to suppress the deformation of the negative electrode, it is possible to consider a method using a material with a high mechanical strength (for example, a tensile strength, a modulus of tensile elasticity and the like) as the collector. However, when a negative electrode material layer of a thin-film negative electrode material is formed on the collector made of such a mechanically-strong material, the adhesion between the negative electrode material layer and the collector becomes insufficient. Consequently, there is a possibility that sufficient charge-discharge cycle characteristics cannot be achieved.

Furthermore, JP 2002-83594 A discloses the technology in which an intermediate layer formed of a material that is alloyed with the negative electrode material is arranged between the negative electrode material layer and the collector whose mechanical strength is higher than the intermediate layer, thereby suppressing the shedding of the negative electrode material and the generation of wrinkles at the time of charging and discharging. In a specific example, a copper layer is used as the intermediate layer, and a nickel foil is used as the collector.

However, since the negative electrode suggested in the above document cannot suppress swelling/shrinkage of the negative electrode material accompanying charging and discharging, repeated charging and discharging may lower the adhesion between the negative electrode material layer and the collector.

### SUMMARY OF THE INVENTION

The object of the present invention is to provide a negative electrode for a lithium secondary battery capable of suppressing its deformation accompanying charging and discharging, a method for manufacturing the same and a lithium secondary battery using the same.

A negative electrode for a lithium secondary battery according to the present invention is capable of storing and releasing lithium reversibly, and this negative electrode includes a collector, and a negative electrode material layer arranged on the collector. The negative electrode material layer contains a thin-film negative electrode material capable of storing and releasing lithium reversibly, and lithium non-storing portions containing a lithium non-storing material are arranged on at least one selected from the group consisting of a surface and an inside of the negative electrode material layer.

A lithium secondary battery according to the present invention includes the above-described negative electrode for a lithium secondary battery, a positive electrode capable of storing and releasing lithium reversibly, and an electrolyte having a lithium conductivity.

A first method for manufacturing a negative electrode for a lithium secondary battery according to the present invention is a method for manufacturing a negative electrode for a lithium secondary battery capable of storing and releasing lithium reversibly, and this method includes (i) arranging a negative electrode material layer containing a thin-film negative electrode material capable of storing and releasing lithium reversibly on a collector, and (ii) arranging lithium non-storing portions containing a lithium non-storing material on a surface of the negative electrode material layer.

A second method for manufacturing a negative electrode for a lithium secondary battery according to the present invention is a method for manufacturing a negative electrode for a lithium secondary battery capable of storing and releasing lithium reversibly, and this method includes (I) arranging lithium non-storing portions containing a lithium non-storing material on a collector, and (II) arranging a negative electrode material layer containing a thin-film negative electrode material capable of storing and releasing lithium reversibly on the collector and the lithium non-storing portions.

### BRIEF DESCRIPTION OF THE DRAWINGS

FIG. 1 is a schematic view showing an example of a negative electrode for a lithium secondary battery according to the present invention.

FIG. 2 is a schematic view showing an example of the distribution of lithium concentration in the negative electrode for a lithium secondary battery shown in FIG. 1.

FIG. 3 is a schematic view showing another example of the negative electrode for a lithium secondary battery according to the present invention.

FIG. 4 is a schematic view showing an example of the distribution of lithium concentration in the negative electrode for a lithium secondary battery shown in FIG. 3.

FIG. 5 is a schematic view showing yet another example of the negative electrode for a lithium secondary battery according to the present invention.

FIG. 6 is a schematic view showing an example of the distribution of lithium concentration in the negative electrode for a lithium secondary battery shown in FIG. 5.

FIG. 7 is a schematic view showing an example of an arrangement of lithium non-storing portions in the negative electrode for a lithium secondary battery according to the present invention.

FIG. 8 is a schematic view showing another example of the arrangement of the lithium non-storing portions in the negative electrode for a lithium secondary battery according to the present invention.

FIG. 9 is a schematic view showing yet another example of the arrangement of the lithium non-storing portions in the negative electrode for a lithium secondary battery according to the present invention.

FIG. 10 is a schematic view showing an example of a lithium secondary battery according to the present invention.

FIGS. 11A and 11B are sectional views for describing an example of a method for manufacturing a negative electrode for a lithium secondary battery according to the present invention.

FIGS. 12A and 12B are sectional views for describing another example of the method for manufacturing the negative electrode for a lithium secondary battery according to the present invention.

### DESCRIPTION OF THE PREFERRED EMBODIMENTS

A negative electrode for a lithium secondary battery according to the present invention is a negative electrode for a lithium secondary battery capable of storing and releasing lithium reversibly and includes a collector and a negative electrode material layer arranged on the collector. Here, the term “lithium” refers to a lithium ion (Li⁺) and/or a lithium atom. Also, the “storing” includes reversibly containing lithium, reversibly forming an alloy, a solid solution or the like with lithium and reversibly forming a chemical bond with lithium.

The material and structure of the collector are not particularly limited as long as the collector is electrically conductive. For example, it is appropriate to use a collector used in a general lithium secondary battery. In particular, the material and structure achieving an excellent adhesion to the negative electrode material layer are preferable. Also, the material that is not alloyed with lithium is preferable. More specifically, it is appropriate to use a material containing at least one element selected from the group consisting of copper, nickel, stainless steel, molybdenum, tungsten, titanium and tantalum, for example. Further, the structure such as a metal foil, an unwoven fabric or a metal collector having a three-dimensional structure is appropriate. Among the above, it is preferable to use the metal foil and, more specifically, a copper foil or the like. An intermediate layer containing a material in which the collector element is dispersed in the negative electrode material layer may be arranged between the collector and the negative electrode material layer. The thickness of the collector is not particularly limited and ranges, for example, from 3 to 30 μm in the case of using the metal foil.

The composition and structure of the negative electrode material layer are not particularly limited as long as the negative electrode material layer contains a thin-film negative electrode material capable of storing and releasing lithium reversibly. The negative electrode material layer may contain the negative electrode material alone (in this case, the negative electrode material=the negative electrode material layer), or also may contain a material other than the negative electrode material or include a layer containing a material other than the negative electrode material, as necessary.

The negative electrode material is not particularly limited as long as it can form a thin film and is capable of storing and releasing lithium reversibly. For example, it is appropriate to use a material containing at least one element selected from the group consisting of carbon (C), silicon (Si), germanium (Ge), tin (Sn), lead (Pb), aluminum (Al), indium (In), zinc (Zn), cadmium (Cd) and bismuth (Bi). In particular, it is preferable to use silicon, germanium or an alloy of silicon and germanium. The negative electrode material may be doped with an element other than the above and may contain, for example, phosphorus, aluminum, arsenic, antimony, boron, gallium, oxygen, nitrogen or the like.

The negative electrode material layer may be a single layer containing the above-mentioned materials or a layered body including plural layers. Individual layers in the layered body may have different compositions, crystallinities and doping element concentrations.

The thickness of the negative electrode material layer is not particularly limited and is, for example, 1 μm or greater. In particular, it preferably ranges from 3 to 25 μm. When it is less than this range, there is a possibility that a charge-discharge capacity sufficient for a lithium secondary battery cannot be obtained.

In the negative electrode for a lithium secondary battery according to the present invention, lithium non-storing portions formed of a lithium non-storing material are arranged on at least one selected from the group consisting of a surface and an inside of the above-mentioned negative electrode material layer. With this structure, it is possible to suppress the storing of lithium near positions where the lithium non-storing portions are arranged in the negative electrode material layer at the time of charging the battery (hereinafter, also simply referred to as “at the time of charging”; the same applies to “at the time of discharging” and “at the time of charging and discharging”). This suppresses the swelling/shrinkage of the negative electrode material at the time of charging and discharging, thereby preventing the deformation of the negative electrode.

The positions where the lithium non-storing portions are arranged are not particularly limited as long as they are at least one selected from the group consisting of the surface and the inside of the negative electrode material layer. For example, the lithium non-storing portions may be arranged on the surface of the negative electrode material layer. Also, the lithium non-storing portions may be arranged on the collector, and the negative electrode material layer may be arranged on the collector and the lithium non-storing portions. Further, there is no particular limitation on the shape of the lithium non-storing portions. For example, when seen from a direction perpendicular to a principal surface of the negative electrode material layer, the shape may be at least one selected from the group consisting of an insular shape, a striped shape and a lattice shape.

Also, in the negative electrode for the lithium secondary battery according to the present invention, an area of the lithium non-storing portions may range from 1% to 15% of the area of a principal surface of the negative electrode material layer when seen from a direction perpendicular to the principal surface. If the area of the lithium non-storing portions is less than 1% of that of the principal surface, it is likely that the deformation of the negative electrode might not be prevented effectively. On the other hand, if the area of the lithium non-storing portions exceeds 15% of that of the principal surface, there are fewer positions in the negative electrode material layer where the charge-discharge reaction can occur. Accordingly, the charge-discharge reaction concentrates in the above-noted positions at the time of charging and discharging, which may cause a degradation of the negative electrode material. In the case where a plurality of the lithium non-storing portions are arranged in a thickness direction of the negative electrode material layer, the area of the lithium non-storing portions corresponds to a two-dimensionally projected area of the lithium non-storing portions when seen from the direction perpendicular to the principal surface of the negative electrode material layer. In other words, in the case where some of the lithium non-storing portions are overlapped in part when seen from the direction perpendicular to the principal surface of the negative electrode material layer, it is appropriate to eliminate the redundant area from consideration. This also applies to the description in the following.

Moreover, in the negative electrode for the lithium secondary battery according to the present invention, when seen from a direction perpendicular to a principal surface of the negative electrode material layer, the lithium non-storing portions may be arranged in a dispersed manner, and each of the lithium non-storing portions may have an area ranging from 0.001 to 3 mm². If the area is smaller than 0.001 mm², it is likely that the deformation of the negative electrode might not be prevented effectively. On the other hand, if the area exceeds 3 mm², the boundary between the positions in the negative electrode material layer where the charge-discharge reaction can occur and those where it cannot occur becomes distinct. Thus, for example, cracks or the like may develop near the above-noted boundary at the time of charging and discharging, so that the negative electrode material may be degraded.

The lithium non-storing material forming the lithium non-storing portions is not particularly limited as long as it has a lithium non-storing property (namely, does not store lithium) within the possible range of electric potentials of the negative electrode in the lithium secondary battery. The above-noted range of electric potentials is, for example, 0.05 to 4 V on a lithium basis. Incidentally, the lithium non-storing material is not necessarily a material that does not store lithium at all but may be a material that stores lithium to some degree (for example, to a degree that the lithium non-storing portions do not vary in shape with charging and discharging and the amount of stored lithium does not affect a battery capacity (e.g., about 10⁻⁴% or less of a total battery capacity)). Further, it may be a material that bonds to lithium irreversibly only during the first several times of charging.

More specifically, as the lithium non-storing material, at least one selected from the group consisting of metal, a metal oxide, an organic low molecular weight compound and an organic high molecular weight compound may be contained. Other than these materials, any optional material further may be contained as necessary.

The metal used for the lithium non-storing material may be at least one selected from the group consisting of copper, nickel, stainless steel, molybdenum, tungsten, titanium and tantalum, for example. The metal oxide used for the lithium non-storing material may be an oxide of the above-mentioned metals, for example. Since these metals and/or metal oxides do not form an alloy or the like with lithium, they can be used as the lithium non-storing material. Furthermore, in the case of using the metal such as copper as the lithium non-storing material, it is possible to diffuse a part of its component inside the negative electrode material layer. The storing of lithium is suppressed in a region where the metal is diffused, so that a stress generated in the negative electrode material layer with the charge-discharge reaction can be alleviated further. Moreover, the adhesion between the negative electrode material layer and the lithium non-storing portions can be improved with the metal diffusion, thereby achieving a still more stable negative electrode.

The organic low molecular weight compound used for the lithium non-storing material can be, for example, a coupling agent such as a silane coupling agent, an aluminate-based coupling agent or a titanate-based coupling agent. The use of the coupling agent as the lithium non-storing material is preferable because the adhesion between the lithium non-storing portions and the negative electrode material layer and/or the collector improves.

The organic high molecular weight compound used for the lithium non-storing material can be at least one selected from the group consisting of rubber, a fluorocarbon resin, a thermosetting resin, a photosensitive resin and a silicone resin, for example. The thermosetting resin may be, for example, an epoxy resin, a phenolic resin, a cyanate resin or a polyphenylene phthalate resin. In particular, the use of the silicone resin as the lithium non-storing material is preferable because the adhesion between the lithium non-storing portions and the negative electrode material layer and/or the collector improves.

Also, a binding agent used for a positive electrode or a negative electrode of general primary and secondary batteries may be used as the lithium non-storing material. For example, it may be possible to use hydrogenated nitrile butadiene rubber (HNBR), hydrogenated styrene butadiene rubber (HSBR), styrene butadiene rubber (SBR), nitrile butadiene rubber (NBR), polyvinyl alcohol (PVA), polyethylene (PE), polyvinylidene fluoride (PVDF), polytetrafluoroethylene (PTFE), polytrifluoroethylene (PTrFE) or the like as the lithium non-storing material.

These organic low molecular weight compound and organic high molecular weight compound can be applied by a general printing or applying process, for example. More specifically, it is appropriate to employ pattern forming techniques by screen printing, spray application, ink-jet printing or photolithography used for semiconductor production, for example. With these techniques, a negative electrode in which the lithium non-storing portions are arranged in a desired shape can be produced relatively easily. Also, in the case of using a solution, slurry or the like of the organic low molecular weight compound and/or the organic high molecular weight compound at the time of printing or applying, by selecting a medium in which the organic low molecular weight compound and/or the organic high molecular weight compound are dissolved or dispersed, a part of the organic low molecular weight compound and/or the organic high molecular weight compound can be allowed to infiltrate into the negative electrode material layer. In this case, it is possible to obtain an effect similar to the case of diffusing the metal inside the negative electrode material layer. Possible combinations of the organic low molecular weight compound and/or the organic high molecular weight compound and the medium include, for example, a combination of polyvinylidene fluoride (PVDF) and N-methylpyrrolidone (NMP) and that of a fluorine-based silane compound and a solution containing a fluorine solvent. It is noted that, in the case where the lithium non-storing material contains the organic high molecular weight compound, the content thereof in the solution or slurry when arranging the lithium non-storing portions may range, for example, from 3 to 30 wt % in view of workability.

In the negative electrode according to the present invention, the lithium non-storing material may be a material having a repelling property to a nonaqueous solution containing lithium, namely, a material shedding a nonaqueous solution containing lithium. Generally, in a lithium secondary battery using a liquid electrolyte, a lithium-conducting nonaqueous electrolyte solution, which is the nonaqueous solution containing lithium, constantly is in contact with the negative electrode, and lithium is delivered back and forth between the nonaqueous electrolyte solution and the negative electrode material. When the lithium non-storing material has a repelling property to the nonaqueous electrolyte solution, it is possible to inhibit the lithium delivery between the nonaqueous electrolyte and the negative electrode material layer near the lithium non-storing portions, so that the storing of lithium can be suppressed further near the lithium non-storing portions. As such a lithium non-storing material, it is appropriate to use a material whose contact angle with respect to the nonaqueous solution containing lithium is 20° or larger (preferably, 30° or larger). In the case of using the material having a repelling property to a nonaqueous solution containing lithium as the lithium non-storing material, when the lithium non-storing portions are arranged on the surface of the negative electrode material layer, it is possible to produce the above-described effect with more advantage.

A preferred example of the material having a repelling property to a nonaqueous solution containing lithium can be a coupling agent having a fluorine atom at its end (for example, a fluorine-based silane coupling agent). The above-noted coupling agent is preferable because of its high repelling property to the above-mentioned nonaqueous solution as well as its high adhesion to the negative electrode material layer and/or the collector. In this case, even when the lithium non-storing portions are made of a monomolecular film formed of the above-noted coupling agent, it is possible to achieve the above-described effect sufficiently.

Further, the lithium non-storing material may contain an oil-repelling agent. This is because a lithium non-storing material having an oil-repelling property can be provided. The oil-repelling agent may be, for example, a fluorine-based silane compound, a fluorine-based coating agent (for example, DAIFREE A441 manufactured by DAIKIN INDUSTRIES, Ltd.), polybutadiene, pitch, perfluoroalkyl ester of a polyacrylic acid or the like.

A lithium secondary battery according to the present invention includes the above-described negative electrode for a lithium secondary battery according to the present invention, a positive electrode capable of storing and releasing lithium reversibly, and an electrolyte having a lithium conductivity. This makes it possible to suppress the deformation of the negative electrode accompanying charging and discharging, so that a lithium secondary battery having excellent charge-discharge cycle characteristics etc. can be provided.

The positive electrode is not particularly limited as long as it can store and release lithium reversibly and may be, for example, a positive electrode used generally in lithium secondary batteries. More specifically, it may be possible to use a positive electrode having a positive electrode collector and a positive electrode material layer containing a positive electrode material layered on the positive electrode collector, for example. In this case, as the positive electrode collector, a material containing an element such as aluminum may be used, for example. Further, the structure of this positive electrode collector can be similar to that of the above-described collector used for the negative electrode.

There is no particular limitation on the structure of the positive electrode material layer as long as the positive electrode material capable of storing and releasing lithium reversibly is contained. For example, the positive electrode material layer containing the positive electrode material, an electrically conductive agent and a binding agent would be appropriate. Such a positive electrode material layer can be formed by dispersing the positive electrode material, the electrically conductive agent and the binding agent into a dispersion medium so as to form slurry, applying the slurry to the positive electrode collector and then drying. The drying further may be followed by rolling. It is preferable that the rolling is carried out while heating reduction rolls to 40° C. to 90° C. The rolling while heating allows the binding agent to be heated and soften, thereby achieving an improved filling density of the positive electrode material layer compared with the case of rolling at room temperature. Also, it is possible to achieve a desired filling density in the positive electrode material layer with a smaller number of rolling passes and to suppress the recovery of the thickness of the positive electrode material layer after rolling. Moreover, while the binding agent is softening with heating, the effective area of adhesion becomes larger, so that the adhesion between the positive electrode materials and between the collector and the positive active material layer can be improved, thereby increasing the positive electrode capacity.

The thickness of the positive electrode collector ranges, for example, from 10 to 30 μm. The thickness of the positive electrode material layer is not particularly limited but may be set suitably according to a designed battery capacity and the like.

It is appropriate that the positive electrode material be similar to a positive electrode material used generally in lithium secondary batteries. For example, an oxide containing lithium and a transition element is appropriate. More specifically, LiCoO₂, LiNiO₂, LiMnO₂, LiMn₂O₄, LiCo_{0.5}Ni_{0.5}O₂ or the like may be used, for example. It also may be possible to use a mixture of plural kinds of the positive electrode materials. Other than the above, any substance capable of inserting and eliminating lithium electrochemically can be used with no particular limitation. The electrically conductive agent is not particularly limited as long as it is electrically conductive, and may be acetylene black, carbon black or graphite powder, for example. The binding agent is not particularly limited as long as it can maintain the shape of the positive electrode material layer after forming the positive electrode, and may be hydrogenated nitrile butadiene rubber (HNBR), hydrogenated styrene butadiene rubber (HSBR), styrene butadiene rubber (SBR), nitrile butadiene rubber (NBR), polyvinyl alcohol (PVA), polyethylene (PE), polyvinylidene fluoride (PVDF), polytetrafluoroethylene (PTFE) or polytrifluoroethylene (PTrFE), for example. It also may be possible to use a mixture of plural kinds of the binding agents. The blend ratio of the binding agent to the positive electrode material ranges, for example, from 2 to 10 parts by weight binding agent with respect to 100 parts by weight positive electrode material.

The lithium secondary battery according to the present invention may have a separator arranged between the negative electrode and the positive electrode. The material and structure of the separator are not particularly limited as long as the separator can retain the electrolyte having a lithium conductivity and maintain an electrical insulation between the negative electrode and the positive electrode. For example, it may be possible to use a separator used generally in lithium secondary batteries such as a porous resin thin film (for example, a porous polypropylene thin film or a porous polyethylene thin film) or a resin non woven fabric containing polyolefin or the like. The thickness of the separator ranges, for example, from 10 to 30 μm. Incidentally, in some cases such as where the electrolyte is a solid electrolyte, the separator is not always necessary.

The electrolyte is not particularly limited as long as it has a lithium conductivity. For example, a nonaqueous electrolyte solution obtained by dissolving an electrolyte containing lithium in a nonaqueous solvent may be used. The electrolyte containing lithium can be a lithium salt such as LiPF₆, LiBF₄, LiClO₄, LiAsF₆ or LiCF₃SO₃, for example. The nonaqueous solvent can be, for example, propylene carbonate, ethylene carbonate, dimethyl carbonate, methyl ethyl carbonate, diethyl carbonate, γ-butyrolactone, 1,2-dimethoxyethane, 1,2-diethoxyethane, ethoxymethoxyethane, or a mixture of these nonaqueous solvents. The concentration of the nonaqueous electrolyte solution is in the range of 0.5 mol/liter or more, for example. Incidentally, other electrolytes such as so-called polymer electrolytes or solid electrolytes also may be used as the electrolyte.

Next, a method for manufacturing a negative electrode for a lithium secondary battery according to the present invention will be described.

A first method for manufacturing a negative electrode for a lithium secondary battery according to the present invention is a method for manufacturing a negative electrode for a lithium secondary battery capable of storing and releasing lithium reversibly, and this method includes (i) arranging a negative electrode material layer containing a thin-film negative electrode material capable of storing and releasing lithium reversibly on a collector, and (ii) arranging lithium non-storing portions containing a lithium non-storing material on a surface of the negative electrode material layer.

Further, a second method for manufacturing a negative electrode for a lithium secondary battery according to the present invention is a method for manufacturing a negative electrode for a lithium secondary battery capable of storing and releasing lithium reversibly, and this method includes (I) arranging lithium non-storing portions containing a lithium non-storing material on a collector, and (II) arranging a negative electrode material layer containing a thin-film negative electrode material capable of storing and releasing lithium reversibly on the collector and the lithium non-storing portions.

With these manufacturing methods, it becomes possible to achieve a negative electrode for a lithium secondary battery according to the present invention having excellent charge-discharge cycle characteristics, etc.

In the (i) arranging or the (II) arranging described above, there is no particular limitation on how to arrange the negative electrode material layer. A general thin-film forming method can be employed. For example, it is appropriate to employ at least one method selected from the group consisting of physical vapor deposition (PVD), CVD, sputtering, a sol-gel process and vacuum deposition. Among the above, at least one method selected from the group consisting of CVD, sputtering and vacuum deposition is preferable. Specific conditions of these thin-film forming methods may be set suitably according to necessary characteristics of the negative electrode material layer. It is appropriate that the element contained in the negative electrode material layer to be arranged, the material thereof and the structure thereof be similar to those of the negative electrode described above. It is appropriate that the material to be used for the collector and the structure of the collector be similar to those of the collector used for the negative electrode described above.

In the (ii) arranging or the (I) arranging described above, there is no particular limitation on how to arrange the lithium non-storing portions on the surface of the negative electrode material layer or the collector. The lithium non-storing material forming the lithium non-storing portions can be selected suitably according to the characteristics of the battery. In the case where the lithium non-storing material is metal or a metal oxide, it is appropriate to arrange the lithium non-storing portions using, for example, CVD, sputtering or vacuum deposition. In the case where the lithium non-storing material is an organic low molecular weight compound or an organic high molecular weight compound, it is appropriate to arrange the lithium non-storing portions using, for example, a general printing or applying process. More specifically, it may be possible to employ pattern forming techniques by screen printing, spray application, ink-jet printing or photolithography used for semiconductor production, for example. With these techniques, the shape of the lithium non-storing portions can be designed relatively freely. Also, the cost for the arrangement can be suppressed. At the time of applying or printing, the organic low molecular weight compound or the organic high molecular weight compound may be dissolved in a solvent or dispersed in a dispersion medium as necessary. It is noted that specific kind of the lithium non-storing material and the shape and positions of the lithium non-storing portions may be similar to those described above.

The following is a detailed description of embodiments of the present invention, with reference to the accompanying drawings. First, the negative electrode for a lithium secondary battery according to the present invention will be described.

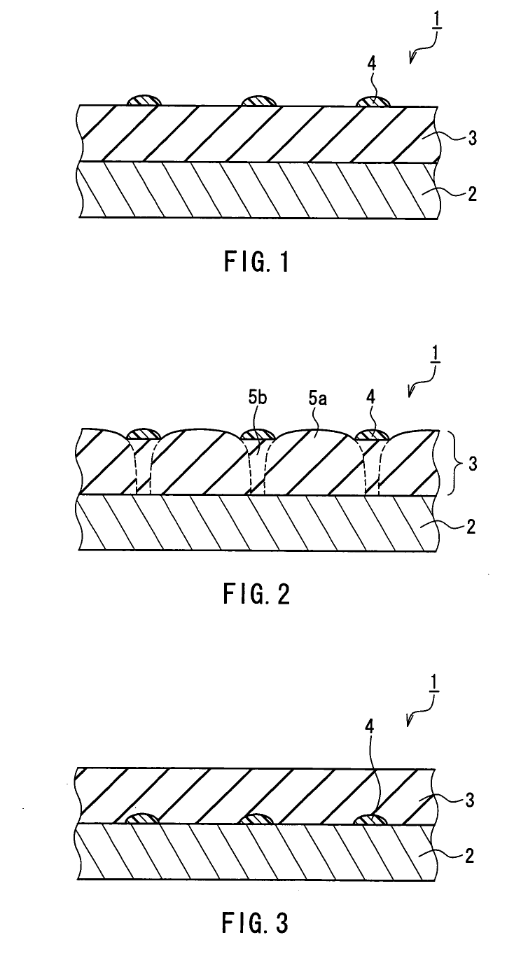

FIG. 1 is a schematic view showing an exemplary negative electrode according to the present invention. A negative electrode 1 shown in FIG. 1 includes a collector 2 and a negative electrode material layer 3 arranged on the collector 2. The negative electrode material layer 3 contains a thin-film negative electrode material capable of storing and releasing lithium reversibly. On the surface of the negative electrode material layer 3, lithium non-storing portions 4 are arranged. In this manner, it is possible to achieve a negative electrode for a lithium secondary battery having excellent charge-discharge cycle characteristics, etc.

FIG. 2 is a schematic view showing an example of a charged state of the negative electrode 1 shown in FIG. 1 (in other words, a state where the negative electrode material layer 3 stores lithium). As shown in FIG. 2, in regions 5b near positions of the lithium non-storing portions 4 in the negative electrode material layer 3, the amount of stored lithium can be made smaller than that in other regions 5a. Depending on the kind of a lithium non-storing material forming the lithium non-storing portions 4 and the shape of the lithium non-storing portions 4, it also is possible to bring the amount of lithium stored in the regions 5b down to substantially 0. In other words, swelling/shrinkage accompanying the lithium storage/release is suppressed in the regions 5b of the negative electrode material layer 3, making it possible to suppress an increase in stress in the regions 5b at the time of charging and discharging. In contrast, in the regions 5a, lithium can be stored/released with substantially no influence by the lithium non-storing portions 4, so that a decrease in capacity of the negative electrode 1 can be minimized.

Here, by arranging the lithium non-storing portions 4 on the surface of the negative electrode material layer 3 in a dispersed manner, it is possible to form the regions 5b in which the swelling/shrinkage of the negative electrode material layer 3 accompanying charging and discharging is suppressed (the regions 5b with substantially no swelling/shrinkage of the negative electrode material layer 3 in the case where the amount of lithium stored in the regions 5b can be brought down to substantially 0) in the negative electrode material layer 3 in a dispersed manner. As a result, the stress inside the negative electrode material layer 3 generated while charging and discharging the battery can be alleviated, thereby suppressing the deformation such as wrinkling in the negative electrode material layer 3 and/or the collector 2. Also, cracks in the negative electrode material layer 3 and shedding thereof from the collector 2 can be suppressed.

In other words, in the negative electrode 1 shown in FIG. 1, the thin-film negative electrode material is contained, thereby reducing the internal resistance, as well as the lithium non-storing portions 4 are arranged on the. surface of the negative electrode material layer 3, thereby improving charge-discharge cycle characteristics.

Although FIG. 2 clearly shows boundaries between the regions 5a and the regions 5b to facilitate understanding, the boundaries are not always clear in an actual negative electrode. In many cases, at the above-described boundaries, the concentration of lithium stored in the negative electrode material layer 3 is considered to vary stepwise or continuously. In other words, a stepwise or continuous gradient of lithium concentration is present inside the negative electrode material layer 3. In terms of the suppression of crack occurrences in the negative electrode material layer 3, it would be more preferable that the lithium concentration varies continuously at the boundaries. This is because the stress generated in the negative electrode material layer 3 can be alleviated. Further, although the surface of the region 5a rises due to lithium storage in the negative electrode 1 shown in FIG. 2, the negative electrode 1 does not necessarily have a shape as shown in FIG. 2 in practice.

FIG. 3 is a schematic view showing another example of the negative electrode according to the present invention.

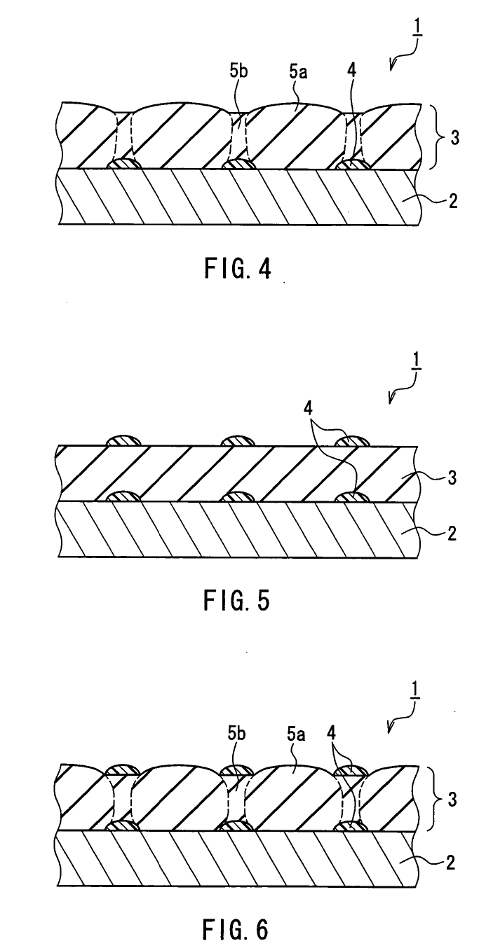

The negative electrode 1 shown in FIG. 3 is different from the negative electrode 1 shown in FIG. 1 in that the lithium non-storing portions 4 are arranged on the collector 2 and the negative electrode material layer 3 is arranged on the collector 2 and the lithium non-storing portions 4. FIG. 4 is a schematic view showing an example of a charged state of the negative electrode 1 shown in FIG. 3 (in other words, a state where the negative electrode material layer 3 stores lithium). As shown in FIG. 4, in the regions 5b near positions of the lithium non-storing portions 4 in the negative electrode material layer 3, since the electron delivery between the negative electrode material and the collector 2 is inhibited, the amount of stored lithium can be made smaller than that in the other regions 5a. Depending on the kind of the lithium non-storing material forming the lithium non-storing portions 4 and the shape of the lithium non-storing portions 4, it also is possible to bring the amount of lithium stored in the regions 5b down to substantially 0. Accordingly, the negative electrode 1 shown in FIG. 3 also can achieve an effect similar to the negative electrode 1 shown in FIG. 1.

FIG. 5 is a schematic view showing yet another example of the negative electrode according to the present invention.

The negative electrode 1 shown in FIG. 5 is different from the negative electrodes 1 shown in FIG. 1 and FIG. 3 in that the lithium non-storing portions 4 are arranged on each of the collector 2 and the negative electrode material layer 3. FIG. 6 is a schematic view showing an example of the charged state of the negative electrode 1 shown in FIG. 5. As shown in FIG. 6, in the regions 5b near positions of the lithium non-storing portions 4 in the negative electrode material layer 3, the amount of stored lithium can be made smaller than that in the other regions 5a. Depending on the kind of the lithium non-storing material forming the lithium non-storing portions 4 and the shape of the lithium non-storing portions 4, it also is possible to bring the amount of lithium stored in the regions 5b down to substantially 0. Accordingly, the negative electrode 1 shown in FIG. 5 also can achieve an effect similar to the negative electrodes 1 shown in FIG. 1 and FIG. 3.

As described above, in the negative electrode according to the present invention, the lithium non-storing portions 4 may be arranged at least one selected from the group consisting of the surface and the inside of the negative electrode material layer 3. It is not always necessary to arrange the lithium non-storing portions 4 as shown in FIGS. 1, 3 and 5. For example, the lithium non-storing portions 4 may be arranged near the center in the negative electrode material layer 3 in its thickness direction (in other words, so as not to contact the collector 2 or the surface of the negative electrode material layer 3).

In the case of arranging the lithium non-storing portions 4 on both of the collector 2 and the negative electrode material layer 3 (in other words, the case of arranging a plurality of the lithium non-storing portions 4 in the thickness direction of the negative electrode material layer 3) as shown in FIG. 5, it is preferable that the lithium non-storing portions 4 on both of them are overlapped when seen from the direction perpendicular to the principal surface of the negative electrode material layer 3. This is because a decrease in the battery capacity can be suppressed. In addition, another layer further may be arranged as necessary between the lithium non-storing portions 4 and the collector 2 or between the lithium non-storing portions 4 and the negative electrode material layer 3.

The lithium non-storing portions 4 have a height (in the direction perpendicular to the principal surface of the negative electrode material layer) ranging, for example, from 0.05 to 10 μm. Within the above-mentioned range, it is particularly preferable that the height of the lithium non-storing portions 4 is about 1.5% to 40% of the thickness of the negative electrode material layer 3. In the case of arranging the lithium non-storing portions 4 on the surface of the collector 2 as shown in FIG. 3, it is preferable that the height of the lithium non-storing portions 4 is smaller than the thickness of the negative electrode material layer 3.

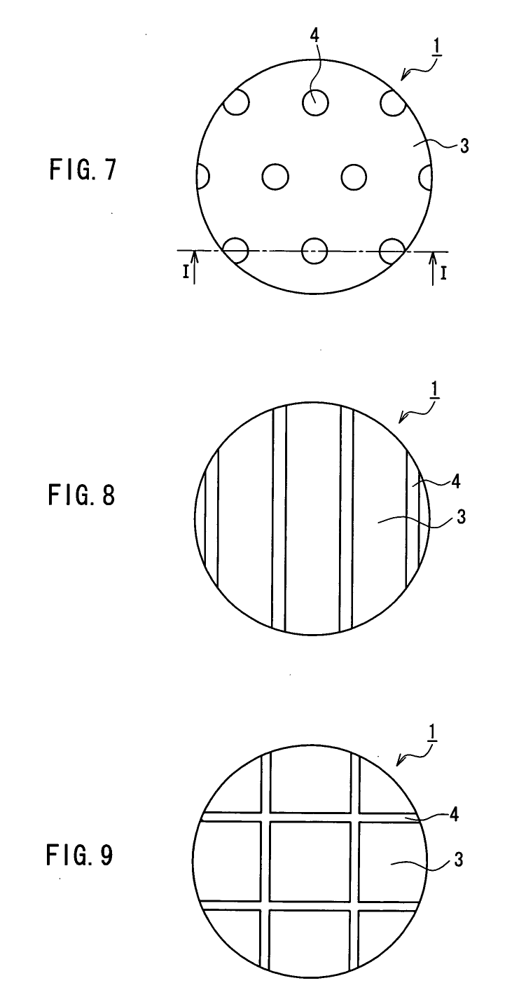

There is no particular limitation on where to arrange the lithium non-storing portions 4 as long as these portions 4 are arranged on at least one of the surface and the inside of the negative electrode material layer 3. The lithium non-storing portions 4 may be arranged in a dispersed manner when seen from the direction perpendicular to the principal surface of the negative electrode material layer 3. They may be arranged in a uniform manner or according to a specific pattern when seen from the direction perpendicular to the principal surface of the negative electrode material layer 3. FIGS. 7 to 9 illustrate exemplary arrangements of the lithium non-storing portions 4. These figures schematically show examples in which the lithium non-storing portions 4 are arranged on the surface of the negative electrode material layer 3 when seen from the direction perpendicular to the principal surface of the negative electrode material layer 3 (the principal surface of the negative electrode 1).

In the negative electrode 1 shown in FIG. 7, the lithium non-storing portions 4 are arranged in an insular pattern when seen from the direction perpendicular to the principal surface of the negative electrode material layer 3. FIG. 1 corresponds to a sectional view of such a negative electrode 1 taken along a line I-I in FIG. 7. In the negative electrode 1 shown in FIG. 8, the lithium non-storing portions 4 are arranged in a striped pattern when seen from the direction perpendicular to the principal surface of the negative electrode material layer 3. Further, in the negative electrode 1 shown in FIG. 9, the lithium non-storing portions 4 are arranged in a lattice-like pattern when seen from the direction perpendicular to the principal surface of the negative electrode material layer 3.

When the lithium non-storing portions 4 are arranged in an insular pattern as shown in FIG. 7, each of them has an average diameter ranging from 50 to 1500 μm, for example. Each island has a height ranging from 0.05 to 10 μm, for example, and an average interval between the islands ranges from 50 to 1500 μm, for example. The shape of the islands is not particularly limited and may be, for example, a substantially circular shape, a substantially elliptical shape, a substantially rectangular shape, a substantially square shape or a substantially polygonal shape.

When the lithium non-storing portions 4 are arranged in a striped pattern as shown in FIG. 8, each of them has a width ranging from 5 to 250 μm, for example, and each stripe may have a height similar to the island described above. An average interval between the stripes ranges from 30 to 1500 μm, for example. The length of each stripe is not limited but may be designed suitably.

When the lithium non-storing portions 4 are arranged in a lattice-like pattern as shown in FIG. 9, each of them has a width and a height similar to the stripes described above, for example. An average interval between the lattices ranges from 30 to 1500 μm, for example.

The arrangement of the lithium non-storing portions 4 is not limited to the examples shown in FIGS. 7 to 9. For example, a mixture of an insular arrangement and a striped arrangement or that of an insular arrangement and a lattice-like arrangement may be possible.

In the following, a lithium secondary battery according to the present invention will be described in detail, with reference to accompanying drawings.

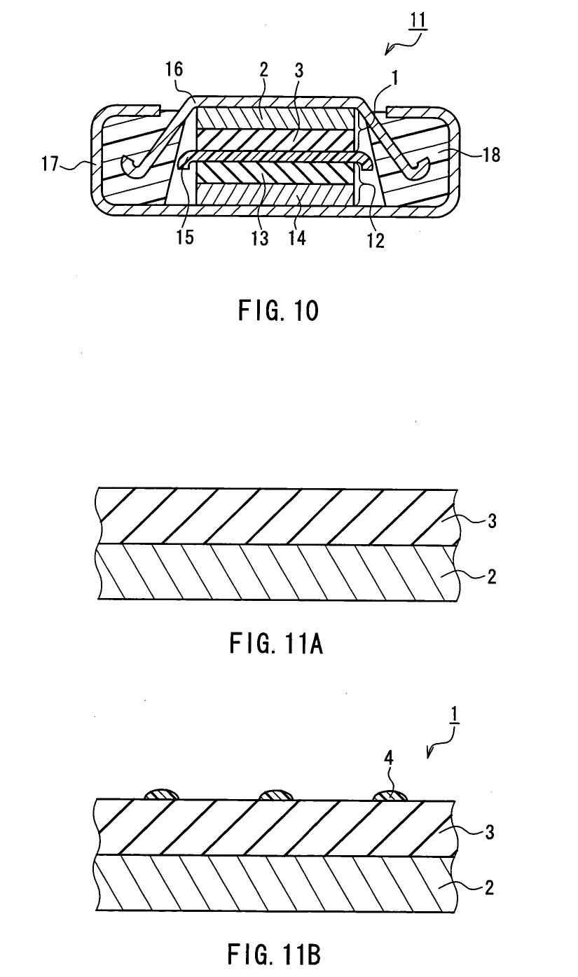

FIG. 10 shows an example of the lithium secondary battery according to the present invention. A lithium secondary battery 11 shown in FIG. 10 includes the negative electrode 1 for a lithium secondary battery described above, a positive electrode 12 capable of storing and releasing lithium reversibly, and an electrolyte having a lithium conductivity. The electrolyte is retained by a separator 15. While being retained by the separator 15, the electrolyte contacts the negative electrode material layer 3 and a positive electrode material layer 13 so as to exchange lithium. The positive electrode 12 includes a positive electrode collector 14 and the positive electrode material layer 13 layered on the positive electrode collector 14. The positive electrode collector 14 is connected electrically to a container case 17 serving also as a positive electrode, whereas the collector 2 of the negative electrode 1 is electrically connected to a sealing plate 16 serving also as a negative electrode. The container case 17 and the sealing plate 16 are fixed by an insulating gasket 18, and electric-power generating elements including the negative electrode 1, the positive electrode 12 and the electrolyte are sealed inside the container case 17. The sealing plate 16, the container case 17 and the insulating gasket 18 may be formed of materials used generally in lithium secondary batteries. In this manner, an internal resistance can be reduced, making it possible to achieve a lithium secondary battery having excellent charge-discharge cycle characteristics, etc.

It should be noted that the lithium secondary battery of the present invention is not limited to a coin-shaped battery as shown in FIG. 10. As long as the negative electrode according to the present invention is used, the lithium secondary battery can have various shapes such as a cylindrical shape, a rectangular shape and a flat shape. Also, its capacity is not particularly limited. The present invention can be applied to various batteries from small batteries used for precision instruments to large batteries used for hybrid vehicles.

Next, methods for manufacturing a negative electrode for a lithium secondary battery according to the present invention will be described in detail referring to the accompanying drawings.

A first method for manufacturing a negative electrode for a lithium secondary battery according to the present invention is for manufacturing a negative electrode capable of storing and releasing lithium reversibly in a lithium secondary battery, and includes (i) arranging a negative electrode material layer 3 containing a thin-film negative electrode material capable of storing and releasing lithium reversibly on a collector 2 as shown in FIG. 11A and (ii) arranging lithium non-storing portions 4 formed of a lithium non-storing material on a surface of the negative electrode material layer 3 as shown in FIG. 11B.

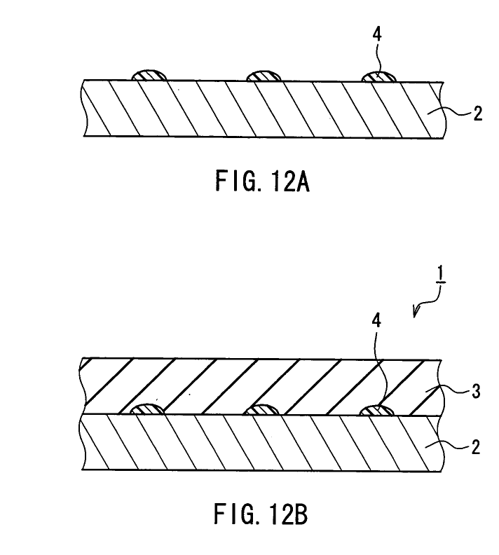

A second method for manufacturing a negative electrode for a lithium secondary battery according to the present invention is for manufacturing a negative electrode capable of storing and releasing lithium reversibly in a lithium secondary battery, and includes (I) arranging lithium non-storing portions 4 formed of a lithium non-storing material on a collector 2 as shown in FIG. 12A and (II) arranging a negative electrode material layer 3 containing a thin-film negative electrode material capable of storing and releasing lithium reversibly on the collector 2 and the lithium non-storing portions 4 as shown in FIG. 12B.

With such manufacturing methods, the shedding and cracking of the negative electrode material accompanying charging and discharging are suppressed, thus reducing the internal resistance. Consequently, it is possible to achieve a negative electrode for a lithium secondary battery having excellent charge-discharge cycle characteristics, etc. It is noted that the (i) arranging and (ii) arranging described above and the (I) arranging and (II) arranging described above may be combined. For example, it may be possible to conduct the (I) arranging, the (II) arranging and (ii) arranging in this order. In this case, the negative electrode 1 shown in FIG. 5 can be formed.

### EXAMPLE

The following is a more specific description of the present invention by way of an example. It should be noted that the present invention is not limited to the example below.

In the present example, 14 kinds of negative electrodes from Sample A to Sample N were produced and incorporated into a lithium secondary battery so as to evaluate battery characteristics (charge-discharge cycle characteristics). Further, a negative electrode of Sample O was produced as a comparative example and evaluated similarly. First, the methods for producing respective negative electrode samples will be described.

### Sample A

First, a silicon thin film (having a thickness of 10 μm) as a negative electrode material was layered on a collector (a copper foil having a thickness of 10 μm) by Radio Frequency (RF) sputtering using Ar gas plasma. In Sample A, the silicon thin film itself served as a negative electrode material layer (the same applies to the samples below).

Subsequently, a lithium non-storing material containing polyvinylidene fluoride (PVDF) was deposited (to be 1.5 μm in thickness) on the surface of the silicon thin film (the negative electrode material layer) by screen printing, thereby forming lithium non-storing portions. In the screen printing, a solution (with a concentration of 3 wt %) obtained by dissolving PVDF in N-methyl-2-pyrrolidone (NMP) was used. The lithium non-storing portions had a substantially circular shape with an average diameter of about 200 μm (whose area was about 0.031 mm²), and about 150 of them were formed uniformly per cm² of the silicon thin film surface as shown in FIG. 7.

### Sample B

First, a layered body of the collector and the negative electrode material layer was formed similarly to Sample A. Next, PVDF as a lithium non-storing material was deposited on the surface of the negative electrode material layer by screen printing, thereby forming the lithium non-storing portions. In the screen printing, the PVDF-NMP solution similar to Sample A was used, and the lithium non-storing portions were arranged in a striped pattern with an average width of 100 μm and an average interval of 1 mm.

### Sample C

First, the layered body of the collector and the negative electrode material layer was formed similarly to Sample A. Next, PVDF as a lithium non-storing material was deposited on the surface of the negative electrode material layer by screen printing, thereby forming the lithium non-storing portions. In the screen printing, the PVDF-NMP solution similar to Sample A was used, and the lithium non-storing portions were arranged in a lattice-like pattern with an average width of 50 μm and an average interval of 1 mm.

### Sample D

First, the surface of a collector (a copper foil having a thickness of 10 μm) was patterned by photolithography using a lithium non-storing material containing a photosensitive resin, thereby forming lithium non-storing portions. As the photosensitive resin, a photosensitive polyimide resin was used. The shape of the arranged lithium non-storing portions was substantially circular (with an average diameter of about 200 μm and an area of about 0.031 mm²) similarly to Sample A, and about 150 of them with a thickness of 1 μm were formed uniformly per cm² of the collector surface.

Subsequently, a silicon thin film (having a thickness of 10 μm) as a negative electrode material was layered on the collector and the lithium non-storing portions by RF sputtering using Ar gas plasma.

### Sample E

First, a lithium non-storing material containing PVDF was deposited on the surface of a collector (a copper foil having a thickness of 10 μm) by screen printing, thereby forming lithium non-storing portions. In the screen printing, a solution (with a concentration of 3 wt %) obtained by mixing and dispersing a fluorine-based coating agent (DAIFREE A441 manufactured by DAIKIN INDUSTRIES, Ltd.) into a solution (with a concentration of 3 wt %) obtained by dissolving PVDF in NMP was used. The lithium non-storing portions (having a thickness of 1.5 μm) were formed in a striped pattern with an average width of 100 μm and an average interval of 1 mm.

Thereafter, similarly to Sample D, a silicon thin film (having a thickness of 10 μm) as a negative electrode material was arranged on the collector and the lithium non-storing portions.

### Sample F

First, similarly to Sample D, substantially circular lithium non-storing portions containing the photosensitive resin were formed on the surface of the collector by photolithography, followed by forming a negative electrode material layer. Next, on the surface of the negative electrode material layer, substantially circular lithium non-storing portions containing PVDF further were formed similarly to Sample A. When the lithium non-storing portions arranged on the surface of the negative electrode material layer were formed, they were positioned so as to correspond substantially to positions of the lithium non-storing portions arranged on the collector surface (so as to substantially overlap the substantially circular lithium non-storing portions arranged on the collector surface when seen from the direction perpendicular to the principal surface of the negative electrode material layer).

### Sample G

First, the layered body of the collector and the negative electrode material layer was formed similarly to Sample A. Next, PVDF as a lithium non-storing material was deposited on the surface of the negative electrode material layer by screen printing, thereby forming lithium non-storing portions. In the screen printing, the PVDF-NMP solution similar to Sample A was used. The lithium non-storing portions had a substantially circular shape with an average diameter of about 100 μm (whose area was about 0.0079 mm²), and about 130 of them were formed uniformly per cm² of the silicon thin film surface as shown in FIG. 7.

### Sample H

First, the layered body of the collector and the negative electrode material layer was formed similarly to Sample A. Next, PVDF as a lithium non-storing material was deposited on the surface of the negative electrode material layer by screen printing, thereby forming lithium non-storing portions. In the screen printing, the PVDF-NMP solution similar to Sample A was used. The lithium non-storing portions had a substantially circular shape with an average diameter of about 250 μm (whose area was about 0.049 mm²), and about 180 of them were formed uniformly per cm² of the silicon thin film surface as shown in FIG. 7.

### Sample I

First, the layered body of the collector and the negative electrode material layer was formed similarly to Sample A. Next, PVDF as a lithium non-storing material was deposited on the surface of the negative electrode material layer by screen printing, thereby forming lithium non-storing portions. In the screen printing, the PVDF-NMP solution similar to Sample A was used. The lithium non-storing portions had a substantially circular shape with an average diameter of about 250 μm (whose area was about 0.049 mm²), and about 245 of them were formed uniformly per cm² of the silicon thin film surface as shown in FIG. 7.

### Sample J

First, the layered body of the collector and the negative electrode material layer was formed similarly to Sample A. Next, PVDF as a lithium non-storing material was deposited on the surface of the negative electrode material layer by screen printing, thereby forming lithium non-storing portions. In the screen printing, the PVDF-NMP solution similar to Sample A was used. The lithium non-storing portions had a substantially circular shape with an average diameter of about 250 μm (whose area was about 0.049 mm²), and about 300 of them were formed uniformly per cm² of the silicon thin film surface as shown in FIG. 7.

### Sample K

First, the layered body of the collector and the negative electrode material layer was formed similarly to Sample A. Next, PVDF as a lithium non-storing material was deposited on the surface of the negative electrode material layer by screen printing, thereby forming lithium non-storing portions. In the screen printing, the PVDF-NMP solution similar to Sample A was used. The lithium non-storing portions had a substantially circular shape with an average diameter of about 250 μm (whose area was about 0.049 mm²), and about 370 of them were formed uniformly per cm² of the silicon thin film surface as shown in FIG. 7.

### Sample L

First, the layered body of the collector and the negative electrode material layer was formed similarly to Sample A. Next, PVDF as a lithium non-storing material was deposited (to be 1.5 μm in thickness) on the surface of the negative electrode material layer by ink-jet printing, thereby forming the lithium non-storing portions. In the ink-jet printing, the PVDF-NMP solution similar to Sample A was used. The lithium non-storing portions had a substantially circular shape with an average diameter of about 20 μm (whose area was about 0.00031 mm²), and about 28500 of them were formed uniformly per cm² of the silicon thin film surface as shown in FIG. 7.

### Sample M

First, the layered body of the collector and the negative electrode material layer was formed similarly to Sample A. Next, PVDF as a lithium non-storing material was deposited on the surface of the negative electrode material layer by screen printing, thereby forming the lithium non-storing portions. In the screen printing, the PVDF-NMP solution similar to Sample A was used. The lithium non-storing portions had a substantially circular shape with an average diameter of about 2 mm (whose area was about 3.1 mm²), and about 3 of them were formed uniformly per cm² of the silicon thin film surface as shown in FIG. 7.

### Sample N

First, the layered body of the collector and the negative electrode material layer was formed similarly to Sample A. Next, a fluorine-based silane coupling agent having a fluorine atom at its end CₙFₙ₊₁C₂H₄Si(OC₂H₅)₃ (a mixture of compounds of n=6 to 12) as a lithium non-storing material shedding a nonaqueous solution was deposited on the surface of the negative electrode material layer by ink-jet printing, thereby forming the lithium non-storing portions. In the ink-jet printing, a solution (with a concentration of 1 wt %) obtained by dissolving a fluorine-based silane coupling agent into isopropyl alcohol (IPA) was used. The lithium non-storing portions had a substantially circular shape with an average diameter of about 200 μm (whose area was about 0.031 mm²), and about 150 of them were formed uniformly per cm² of the silicon thin film surface as shown in FIG. 7.

### Sample O

### Comparative Example

Similarly to Sample A, a silicon thin film (having a thickness of 10 μm) as a negative electrode material was layered on a collector (a copper foil having a thickness of 10 μm) by RF sputtering using Ar gas plasma. No lithium non-storing portions were provided.

Then, using each of the above-described negative electrode samples, a lithium secondary battery as shown in FIG. 10 was produced so as to evaluate its battery characteristics. The following is a description of how to produce the lithium secondary battery used for evaluation.

A positive electrode used in the lithium secondary battery was produced as follows. An aluminum foil (having a thickness of 15 μm) was used as a positive electrode collector. Lithium cobaltate (LiCoO₂) was used as a positive electrode material. First, 2.5 parts by weight acetylene black and 2.5 parts by weight graphite as electrically conductive agents and 100 parts by weight positive electrode material powder were mixed using a Henschel mixer. Then, this mixture was mixed and dispersed into a solution (with a concentration of 3 wt %) obtained by dissolving PVDF serving as a binding agent in NMP, thus preparing a positive electrode material paste. Next, this positive electrode material paste was applied onto the positive electrode collector and dried. After rolling, a positive electrode whose positive electrode material layer had a thickness of 70 μm and filling density was 3.3 g/cm³ was obtained.

The negative electrode and positive electrode produced as described above and a separator (having a thickness of 20 μm) formed of a porous polyethylene film were layered such that these electrodes sandwich the separator. In a separate process, 1 mol lithium phosphate hexafluoride (LiPF₆) was dissolved in a mixed solvent of ethylene carbonate and methyl ethyl carbonate (mixture ratio by volume=1:2), thus preparing a nonaqueous electrolyte solution. Then, the nonaqueous electrolyte solution and the layered body of the negative electrode, the positive electrode and the separator were put in a stainless steel container case, and sealed with a sealing plate and an insulating gasket, thereby producing a coin-shaped lithium secondary battery as shown in FIG. 10. The battery capacity of the obtained lithium secondary battery was designed to be 9.0 mAh.

The following is a description of how to evaluate the battery. The battery produced as above was subjected to repeated charge-discharge cycles at 20° C. Each cycle consisted of charging at a constant current (9.0 mA) until a battery voltage reached 4.2 V and then discharging at a constant current (9.0 mA) until the battery voltage dropped down to 3.0 V. The discharge capacities of the battery at the 1st, 10th, 50th, 200th and 500th cycles were measured so as to evaluate charge-discharge cycle characteristics of the battery. Table 1 shows the results. Incidentally, Table 1 also shows a ratio of the lithium non-storing portions in a principal surface of the negative electrode material layer included in each battery when seen from the direction perpendicular to this principal surface (hereinafter, referred to as an area coverage).

TABLE 1

| | | | | | | | Capacity |
|---|---|---|---|---|---|---|---|
| | Discharge capacity (mAh/cell) | | | | | Area | retention |
| | 1st | 10th | 50th | 200th | 500th | coverage | at 500th |
| Sample | cycle | cycle | cycle | cycle | cycle | (%) | cycle (%) |
| A | 9.0 | 8.7 | 8.4 | 7.3 | 6.2 | 5 | 67 |
| B | 8.9 | 8.6 | 8.3 | 7.5 | 6.4 | 9 | 72 |
| C | 8.8 | 8.6 | 8.3 | 7.7 | 6.6 | 9 | 75 |
| D | 9.0 | 8.7 | 8.4 | 7.2 | 6.1 | 5 | 68 |
| E | 8.9 | 8.6 | 8.3 | 7.4 | 6.3 | 9 | 71 |
| F | 8.8 | 8.5 | 8.2 | 7.1 | 6.0 | 5 | 68 |
| G | 9.1 | 9.0 | 8.4 | 7.2 | 6.1 | 1 | 67 |
| H | 8.8 | 8.5 | 8.3 | 7.4 | 6.3 | 9 | 71 |
| I | 8.7 | 8.4 | 8.1 | 7.1 | 5.9 | 12 | 68 |
| J | 8.6 | 8.3 | 7.9 | 7.0 | 5.9 | 15 | 68 |
| K | 8.3 | 8.0 | 7.6 | 6.7 | 5.1 | 18 | 62 |
| L | 9.2 | 8.8 | 8.4 | 6.5 | 4.5 | 9 | 49 |
| M | 8.9 | 8.5 | 7.5 | 6.1 | 3.9 | 9 | 44 |
| N | 9.0 | 8.7 | 8.4 | 7.3 | 6.3 | 5 | 70 |
| O | 9.3 | 9.0 | 8.6 | 6.5 | 3.9 | 0 | 42 |
| (comp. ex.) | | | | | | | |

As becomes clear from Table 1, the batteries using the negative electrodes of Samples A to N of the example had a slightly lower initial discharge capacity but achieved a considerably improved capacity retention, which was calculated from the ratio of the discharge capacity at the 500th cycle with respect to that at the 1st cycle, compared with the battery using the negative electrode of Sample O of the comparative example. This showed that, by arranging the lithium non-storing portions, the battery with improved charge-discharge cycle characteristics was obtained.

Also, the batteries using the negative electrodes of Samples A to J and N with an area coverage of 1% to 15% had improved discharge capacity and capacity retention compared with the battery using the negative electrode of Sample K with an area coverage of 18%. Since Sample K had an area coverage exceeding 15%, it had less positions in the negative electrode material layer where a charge-discharge reaction can occur than the negative electrodes of Samples A to J and N. Therefore, the charge-discharge reaction concentrates in these positions at the time of charging and discharging, so that the negative electrode material was degraded. Consequently, the charge-discharge cycle characteristics of the battery using the negative electrode of Sample K were degraded further compared with the batteries using the negative electrodes of Samples A to J and N.

Further, the batteries using the negative electrodes of Samples A, D, F to J and N whose area of the lithium non-storing portions ranged from 0.001 to 3 mm² had improved discharge capacity and capacity retention compared with the battery using the negative electrode of Sample L whose area of the lithium non-storing portions was about 0.00031 mm² and the battery using the negative electrode of Sample M whose area of the lithium non-storing portions was about 3.1 mm². Since Sample L had an area of the lithium non-storing portions of 0.001 mm² or smaller, it was not able to prevent the deformation of the negative electrode effectively, so that the charge-discharge cycle characteristics of the battery using the negative electrode of Sample L were degraded further compared with the batteries using the negative electrodes of Samples A, D, F to J and N. On the other hand, since Sample M had an area of the lithium non-storing portions exceeding 3 mm², the boundary between the positions in the negative electrode material layer where the charge-discharge reaction can occur and those where it cannot occur became distinct. Accordingly, the negative electrode material near the boundary was degraded at the time of charging and discharging, so that the charge-discharge cycle characteristics of the battery using the negative electrode of Sample M were degraded further compared with the batteries using the negative electrodes of Samples A, D, F to J and N.

By comparing Samples B, C and H all having an area coverage of 9%, it was found that the capacity retention after 500 cycles of the sample with lattice-like lithium non-storing portions was better than that of the sample with striped lithium non-storing portions, which was still better than that of the sample with insular lithium non-storing portions. Also, by comparing Samples A, D and F, there was no substantial difference among the case in which the lithium non-storing portions were arranged on the collector surface, that in which they were arranged on the negative electrode material layer surface and that in which they were arranged on both of the collector surface and the negative electrode material layer surface.

As described above, in accordance with the present invention, a lithium secondary battery having excellent charge-discharge cycle characteristics, etc can be provided. Also, it is possible to provide a negative electrode for a lithium secondary battery achieving such a lithium secondary battery and a method for manufacturing the same.

There is no particular limitation on the use of the lithium secondary battery according to the present invention. For example, regardless of its capacity, the lithium secondary battery of the present invention can be applied to various purposes from small batteries used for portable equipment to large batteries used for hybrid vehicles.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A negative electrode for a lithium secondary battery capable of storing and releasing lithium reversibly, the negative electrode comprising:
a collector; and
a negative electrode material layer arranged on the collector;
wherein the negative electrode material layer comprises a thin-film negative electrode material capable of storing and releasing lithium reversibly, and
lithium non-storing portions comprising a lithium non-storing material are arranged on at least one selected from the group consisting of a surface and an inside of the negative electrode material layer.

2. The negative electrode for a lithium secondary battery according to claim 1, wherein the lithium non-storing portions are arranged on the surface of the negative electrode material layer.

3. The negative electrode for a lithium secondary battery according to claim 1, wherein the lithium non-storing portions are arranged on the collector, and the negative electrode material layer is arranged on the collector and the lithium non-storing portions.

4. The negative electrode for a lithium secondary battery according to claim 1, wherein an area of the lithium non-storing portions ranges from 1% to 15% of the area of a principal surface of the negative electrode material layer when seen from a direction perpendicular to the principal surface.

5. The negative electrode for a lithium secondary battery according to claim 1, wherein the lithium non-storing portions have at least one selected from the group consisting of an insular shape, a striped shape and a lattice shape when seen from a direction perpendicular to a principal surface of the negative electrode material layer.

6. The negative electrode for a lithium secondary battery according to claim 1, wherein when seen from a direction perpendicular to a principal surface of the negative electrode material layer, the lithium non-storing portions are arranged in a dispersed manner, and each of the lithium non-storing portions has an area ranging from 0.001 to 3 mm².

7. The negative electrode for a lithium secondary battery according to claim 1, wherein the lithium non-storing material comprises at least one selected from the group consisting of metal, a metal oxide, an organic low molecular weight compound and an organic high molecular weight compound.

8. The negative electrode for a lithium secondary battery according to claim 7, wherein the organic low molecular weight compound is a coupling agent.

9. The negative electrode for a lithium secondary battery according to claim 7, wherein the organic high molecular weight compound is at least one selected from the group consisting of rubber, a fluorocarbon resin, a thermosetting resin, a photosensitive resin and a silicone resin.

10. The negative electrode for a lithium secondary battery,according to claim 1, wherein the lithium non-storing material is a material having a repelling property to a nonaqueous solution containing lithium.

11. The negative electrode for a lithium secondary battery according to claim 10, wherein the material having the repelling property to the nonaqueous solution containing lithium is a coupling agent having a fluorine atom at its end.

12. The negative electrode for a lithium secondary battery according to claim 1, wherein the negative electrode material comprises at least one element selected from the group consisting of C, Si, Ge, Sn, Pb, Al, In, Zn, Cd and Bi.

13. A lithium secondary battery comprising:
the negative electrode for a lithium secondary battery according to claim 1;
a positive electrode capable of storing and releasing lithium reversibly; and
an electrolyte having a lithium conductivity.

14. A method for manufacturing a negative electrode for a lithium secondary battery capable of storing and releasing lithium reversibly, the method comprising:
(i) arranging a negative electrode material layer comprising a thin-film negative electrode material capable of storing and releasing lithium reversibly on a collector; and
(ii) arranging lithium non-storing portions comprising a lithium non-storing material on a surface of the negative electrode material layer.

15. The method according to claim 14, wherein the negative electrode material comprises at least one element selected from the group consisting of C, Si, Ge, Sn, Pb, Al, In, Zn, Cd and Bi, and
the (i) arranging is carried out by at least one selected from the group consisting of a physical vapor deposition, a chemical vapor deposition, sputtering, a sol-gel process and a vacuum deposition.

16. The method according to claim 14, wherein the (ii) arranging is carried out by at least one selected from the group consisting of application and printing.

17. The method according to claim 14, wherein in the (ii) arranging, the lithium non-storing portions are arranged so as to have at least one selected from the group consisting of an insular shape, a striped shape and a lattice shape when seen from a direction perpendicular to a principal surface of the negative electrode material layer.

18. A method for manufacturing a negative electrode for a lithium secondary battery capable of storing and releasing lithium reversibly, the method comprising:
(I) arranging lithium non-storing portions comprising a lithium non-storing material on a collector; and
(II) arranging a negative electrode material layer comprising a thin-film negative electrode material capable of storing and releasing lithium reversibly on the collector and the lithium non-storing portions.

19. The method according to claim 18, wherein the (I) arranging is carried out by at least one selected from the group consisting of application and printing.

20. The method according to claim 18, wherein in the (I) arranging, the lithium non-storing portions are arranged so as to have at least one selected from the group consisting of an insular shape, a striped shape and a lattice shape when seen from a direction perpendicular to a principal surface of the negative electrode material layer.

21. The method according to claim 18, wherein the negative electrode material comprises at least one element selected from the group consisting of C, Si, Ge, Sn, Pb, Al, In, Zn, Cd and Bi, and
the (II) arranging is carried out by at least one selected from the group consisting of a physical vapor deposition, a chemical vapor deposition, sputtering, a sol-gel process and a vacuum deposition.
